(19) United States
(12) Patent Application Publication
(10) Pub. No.: US 2023/0153066 A1
(43) Pub. Date: May 18, 2023

(54) METHOD AND APPARATUS FOR MEASURING WEIGHT OF DISCRETE ENTITY

(71) Applicant: ELECTRONICS AND TELECOMMUNICATIONS RESEARCH INSTITUTE, Daejeon (KR)

(72) Inventors: Jong-Ryul LEE, Daejeon (KR); Yong-Hyuk MOON, Daejeon (KR); Yong-Ju LEE, Daejeon (KR)

(73) Assignee: ELECTRONICS AND TELECOMMUNICATIONS RESEARCH INSTITUTE, Daejeon (KR)

(21) Appl. No.: 17/702,242

(22) Filed: Mar. 23, 2022

(30) Foreign Application Priority Data
Nov. 12, 2021 (KR) 10-2021-0155956

(51) Int. Cl. G06F 7/499; G06F 7/523; G06F 7/50; G06N 3/04

(52) U.S. Cl. CPC G06F 7/49947; G06F 7/50; G06F 7/523; G06N 3/04

(57) ABSTRACT

Disclosed herein is a method for measuring the weight of a discrete entity, performed in a neural network model configured with multiple layers, the method including receiving data configured with the indices of discrete entities, converting the data into embedding vectors corresponding to respective indices through an embedding layer, generating a masked vector through element-wise multiplication between a mask vector and the embedding vector, calculating a loss using output based on the masked vector, and training the model based on the loss.

### CROSS REFERENCE TO RELATED APPLICATION

This application claims the benefit of Korean Patent Application No. 10-2021-0155956, filed Nov. 12, 2021, which is hereby incorporated by reference in its entirety into this application.

### BACKGROUND OF THE INVENTION

### 1. Technical Field

The present invention relates to an importance calculation method for a neural network model that takes discrete entities represented as embedding vectors as input.

More particularly, the present invention relates to technology for lightening a model in consideration of the importance of individual discrete entities.

### 2. Description of the Related Art

Recently, inference by neural network models, which has commonly been performed in servers, has come to be performed in lightweight devices (e.g., smartphones, robots, TVs, or the like), and research for reducing the amount of memory for storing a neural network model and the amount of computation is actively underway. For such reasons, lightweight methods for a natural-language-processing model, a knowledge-graph-based inference model, and a recommender system model, which are representative neural network models for dealing with discrete entities, are also being researched extensively.

Particularly, because an embedding matrix for processing discrete entities, such as words in a natural-language-processing model, node embeddings in a knowledge-graph-based inference model, or items in a recommender system model, generally has a very large size, many methods for effectively reducing the size thereof have been proposed.

However, the existing methods are based on a matrix approximation method or a quantization method in which the importance of individual entities is not taken into consideration, or use a lightweight method in which importance set based on simple heuristics, i.e., frequencies, is used as a weight, so the methods do not exhibit effective performance and are occasionally inappropriate depending on the task.

### [Documents of Related Art]

(Patent Document 1) Korean Patent Application Publication No. 10-2021-0067499, titled “Method for lightweight speech synthesis of end-to-end deep convolutional text-to-speech system”.

### SUMMARY OF THE INVENTION

An object of the present invention is to provide a method for measuring the optimum importance of each entity in a neural network model for processing discrete entities.

Another object of the present invention is to provide the importance of each discrete entity in order to effectively apply a method for lightening an embedding layer.

In order to accomplish the above objects, a method for measuring the weight of a discrete entity, performed in a neural network model configured with multiple layers, according to an embodiment of the present invention includes receiving data configured with the indices of discrete entities, converting the data into embedding vectors corresponding to respective indices through an embedding layer, generating a masked vector through element-wise multiplication between a mask vector and the embedding vector, calculating a loss using output based on the masked vector, and training the model based on the loss.

Here, generating the masked vector may include performing a floor operation on a weight value for the discrete entity, assigning 1 to an index corresponding to an integer equal to or less than a value resulting from the floor operation, and assigning 0 to an index corresponding to an integer greater than the value resulting from the floor operation.

Here, the mask vector may represent values to be used as 1 and represent values not to be used as 0, among the elements of the embedding vector.

Here, generating the masked vector may further include adding a value corresponding to a gate function for learning the weight value to each of the elements of the masked vector.

Here, the gate function may have a value close to 0 such that learning of the weight value is possible, and may be a function that is differentiable in a preset section.

Here, the gate function may be a function of Equation (1) below, and L may be a positive integer equal to or greater than 1000,

$$\text{B} \left(\text{x}\right) = \frac{L x - \left⌊L x\right⌋}{L}$$

Here, calculating the loss may comprise calculating a final loss based on a first loss corresponding to the difference between output and a correct answer of the neural network model and on a second loss corresponding to the difference between a target sparsity and the sparsity of a masking vector generated based on a weight vector configured with respective weight values for the discrete entities.

Here, generating the masked vector may further include compensating for a rapid change in output, which is caused due to application of masking to the embedding vector.

Also, in order to accomplish the above objects, an apparatus for measuring the weight of a discrete entity according to an embodiment of the present invention includes memory in which at least one program is recorded and a processor for executing the program. The program may include instructions for performing receiving data configured with the indices of discrete entities, converting the data into embedding vectors corresponding to respective indices through an embedding layer, generating a masked vector through element-wise multiplication of a mask vector and the embedding vector, calculating a loss using output based on the masked vector, and training a model based on the loss.

Here, generating the masked vector may include performing a floor operation on a weight value for the discrete entity, assigning 1 to an index corresponding to an integer equal to or less than a value resulting from the floor operation, and assigning 0 to an index corresponding to an integer greater than the value resulting from the floor operation.

Here, the mask vector may represent values to be used as 1 and represent values not to be used as 0, among the elements of the embedding vector.

Here, generating the masked vector may further include adding a value corresponding to a gate function for learning the weight value to each of the elements of the masked vector.

Here, the gate function may have a value close to 0 such that learning of the weight value is possible, and may be a function that is differentiable in a preset section.

Here, the gate function may be a function of Equation (1) below, and L may a positive integer equal to or greater than 1000,

$$\text{B} \left(\text{x}\right) = \frac{L x - \left⌊L x\right⌋}{L}$$

Here, calculating the loss may comprise calculating a final loss based on a first loss corresponding to the difference between output and a correct answer of a neural network model and on a second loss corresponding to the difference between a target sparsity and the sparsity of a masking vector generated based on a weight vector configured with respective weight values for the discrete entities.

Here, generating the masked vector may further include compensating for a rapid change in output, which is caused due to application of masking to the embedding vector.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating the structure of a general neural network that deals with discrete entities using an embedding layer;

FIG. 2 is a flowchart illustrating a method for measuring the weight of a discrete entity according to an embodiment of the present invention;

FIG. 3 is an exemplary view of an embedding matrix in which embedding vectors of discrete entities are collected;

FIG. 4 is an exemplary view illustrating an embedding vector in an embedding matrix, a mask vector therefor, and a masked vector;

FIG. 5 is a view illustrating an embedding matrix generated by multiplying each discrete entity by a mask vector;

FIG. 6 is a view illustrating an example of an embedding matrix in a method according to an embodiment of the present invention;

FIG. 7 is a view illustrating generation of a mask vector using a weight value indicating the importance of a discrete entity and application of the mask vector to an embedding vector;

FIG. 8 is a view illustrating an example of a trainable mask vector and a masked embedding vector to which the trainable mask vector is applied;

FIG. 9 is a view illustrating an example of a neural network model that uses an embedding layer to which trainable mask vectors are applied according to an embodiment of the present invention;

FIG. 10 is a view illustrating an example of a method for applying a compensator layer for compensating a masked embedding vector;

FIG. 11 is a view illustrating an example of a neural network model to which a compensator layer is applied according to an embodiment of the present invention; and

FIG. 12 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

The present invention pertains to Artificial Intelligence (AI) and machine-learning methodology, and is technology for calculating the importance of each discrete entity in connection with inference of a model in a neural network model that receives discrete entities (e.g., words, graph nodes, items, and the like) represented as embedding vectors as input. The importance may be used as the score of each entity when an embedding matrix of discrete entities is made lightweight or compressed.

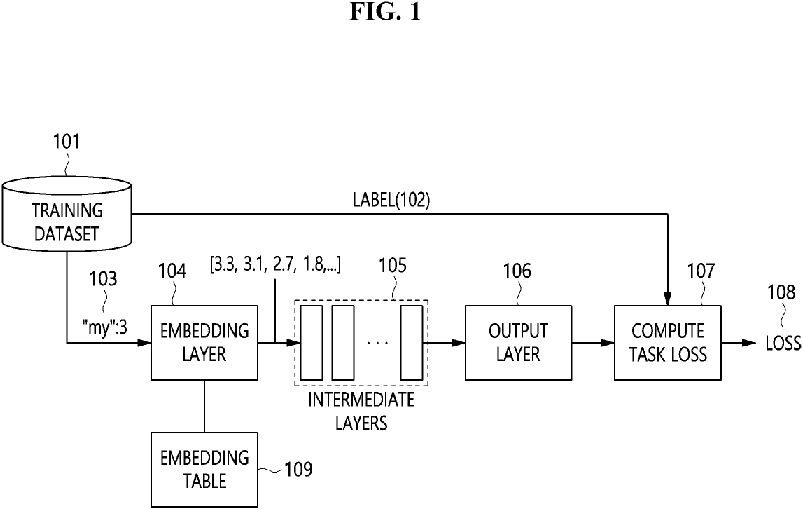

FIG. 1 is a view illustrating the structure of a general neural network model that deals with discrete entities using an embedding layer.

Referring to FIG. 1, input 103 received from a training dataset 101 is configured with the index number of each discrete entity, and is converted into an embedding vector located at a corresponding index in an embedding table 109 when passing through an embedding layer 104.

The converted embedding vectors are transferred to a final output layer 106 via intermediate layers 105, and the difference between a correct answer label 102 and the result output from the final output layer 106 is calculated (107) and represented as a loss 108. The loss is minimized using an optimization method, such as a gradient descent method, whereby the model is trained.

The present invention relates to technology that is applied to an embedding layer in a neural network model for dealing with general discrete entities, as shown in FIG. 1, in order to automatically and optimally infer the importance of each entity for inference of the model.

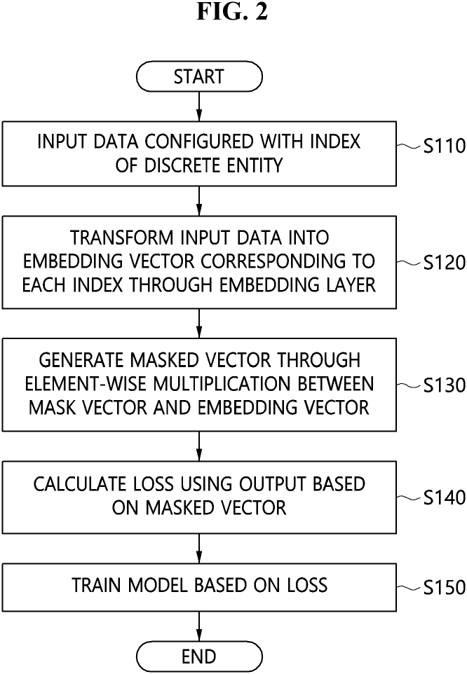

FIG. 2 is a flowchart illustrating a method for measuring the weight of a discrete entity according to an embodiment of the present invention.

Specifically, the method for measuring the weight of a discrete entity according to an embodiment of the present invention may be performed in a neural network model configured with multiple layers.

Here, the multiple layers may include an embedding layer, a compensator layer, an intermediate layer, an output layer, a loss function measurement unit, and the like.

Here, the types and number of layers are merely examples, and the scope of the present invention is not limited thereto.

Referring to FIG. 2, in the method performed in an apparatus for measuring the weight of a discrete entity, data configured with the indices of discrete entities is input at step S110.

Subsequently, the input data is converted into embedding vectors corresponding to the respective indices through the embedding layer at step S120.

Subsequently, a masked vector is generated at step S130 through element-wise multiplication between a mask vector and the embedding vector.

Here, the mask vector may be a vector acquired by representing the values to be used, among the elements of a certain embedding vector 301, as 1 and representing the values not to be used as 0, among the elements of the certain embedding vector 301, according to a specific method.

Here, generating the masked vector at step S130 may include performing a floor operation on the weight value for the discrete entity, assigning 1 to an index corresponding to an integer equal to or less than the value resulting from the floor operation, and assigning 0 to an index corresponding to an integer greater than the value resulting from the floor operation.

For example, when the weight value of a specific discrete entity is 2.1, a floor operation is performed on 2.1, 1 may be assigned to an index corresponding to an integer equal to or less than 2, which is the value resulting from the floor operation, and 0 may be assigned to an index corresponding to an integer greater than 2.

Here, generating the masked vector at step S130 may further include adding a value corresponding to a gate function for learning the weight value to each of the elements of the masked vector.

Here, the gate function may have a value close to 0 such that it is possible to learn the weight value, and may be a function that is differentiable in a preset section.

For example, the gate function may be set to have a value equal to or less than 0.001 in a preset section.

That is, training of a mask vector, which is generally impossible, may be realized using a gate function that has a value close to 0 and that has a nonzero value as the result of differentiating the gate function.

For example, the gate function may correspond to the function of Equation (1) below. Here, L in Equation (1) below may be a positive value that is sufficiently large such that the value of the gate function approaches 0. For example, L in Equation (1) below may be a positive integer equal to or greater than 1000.

$$\text{B} \left(\text{x}\right) = \frac{L x - \left⌊L x\right⌋}{L}$$

Here, generating the masked vector at step S130 may further include compensating for a rapid change in output, which is caused due to application of masking to the embedding vector.

Subsequently, a loss is calculated using the output based on the masked vector at step S140.

Here, calculating the loss at step S140 may comprise calculating a final loss based on a first loss corresponding to the difference between the output of the neural network model and the correct answer thereof and on a second loss corresponding to the difference between a target sparsity and the sparsity of a masking vector generated based on a weight vector configured with the weight values of the respective discrete entities.

That is, the final loss may be calculated by calculating the weighted sum of the first loss and the second loss using hyperparameters. However, any of various methods may be adopted as the method of calculating the final loss, and the method of calculating the final loss is not limited by the above-described configuration.

Subsequently, the model is trained based on the loss at step S150.

Here, the process of training the model at step S150 may be performed using an optimization method, such as a gradient descent method, so as to minimize the loss.

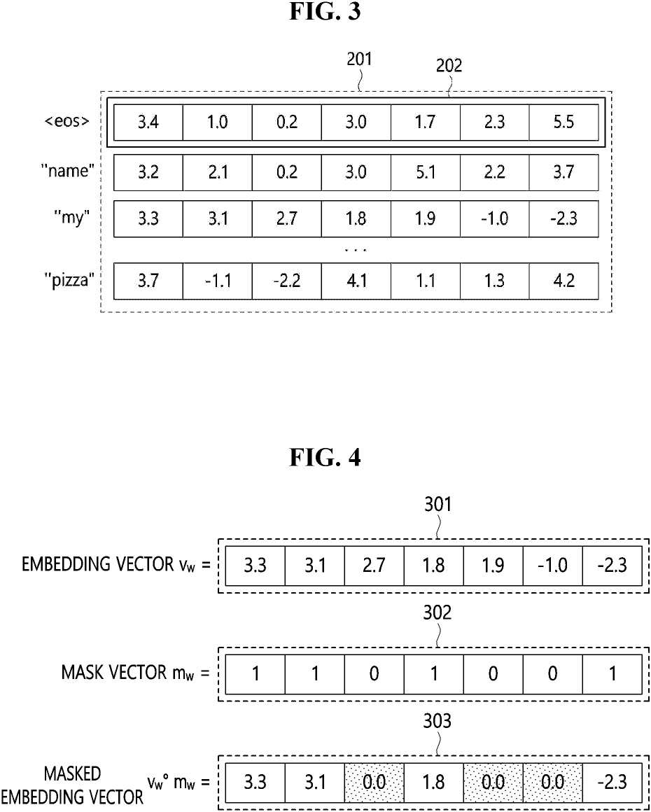

FIG. 3 is an exemplary view of an embedding matrix in which embedding vectors of discrete entities are collected.

Referring to FIG. 3, because an embedding matrix 201 has embedding vectors 202 as the rows thereof according to indices indicative of respective discrete entities, it has a number of embedding vectors equal to the number of discrete entities. Generally, because a large number of discrete entities is processed by a model, the size of an embedding matrix accounts for a large proportion of the total size of the model.

FIG. 4 is an exemplary view of an embedding vector in an embedding matrix, a mask vector therefor, and a masked vector.

Referring to FIG. 4, when a certain embedding vector 301 is given, a mask vector 302 acquired by representing the values to be used, among the elements of the vector 301, as 1 and representing the values not to be used, among the elements of the vector 301, as 0 according to a specific method is present, and a masked vector 303 may be acquired through element-wise multiplication of the two vectors.

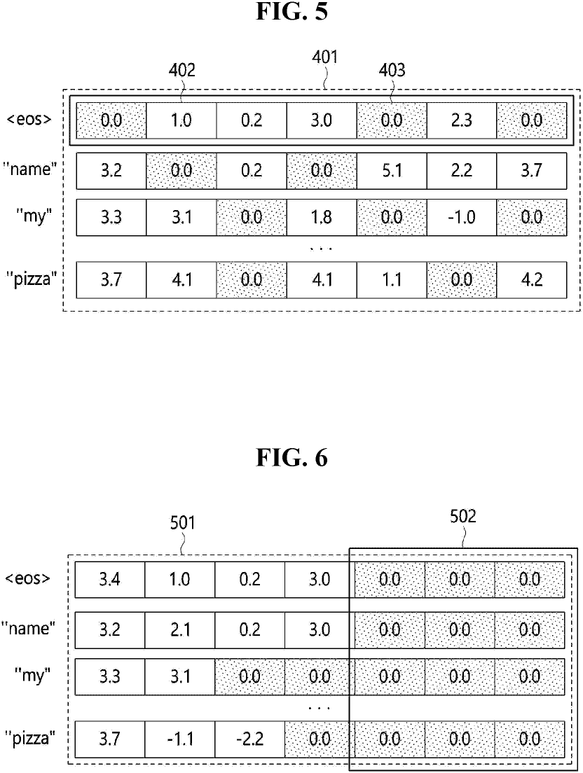

FIG. 5 is a view illustrating an embedding matrix generated by multiplying each discrete entity by a mask vector.

Referring to FIG. 5, in the masked embedding matrix 401, the index 403 to which a mask is applied has 0 as the value thereof, and the other indices 402 have the same values as the values in the original embedding matrix.

FIG. 6 is a view illustrating an example of an embedding matrix used in a method according to an embodiment of the present invention.

The embedding matrix 401 in FIG. 5 is an example that represents a general embedding matrix generated using an arbitrary mask vector generation method, and the present invention proposes technology for generating a masked embedding matrix 501 with mask vectors that are adjusted to have consecutive 0s from the end.

The embedding matrix 501 in FIG. 6 is masked with mask vectors adjusted to have consecutive 0s from the end. Therefore, when a partial matrix 502 is defined such that zero vectors, each of which starts from the end of each column of the embedding matrix 501, have a maximum size, the rank of the embedding matrix 501 becomes lower than the rank of the embedding matrix 201, which is the embedding matrix before masking, by the number of column vectors of the partial matrix 502.

Using this characteristic, the number of 0s in the mask vector of each discrete entity is adjusted, whereby the size of information allocated to each entity may be effectively limited.

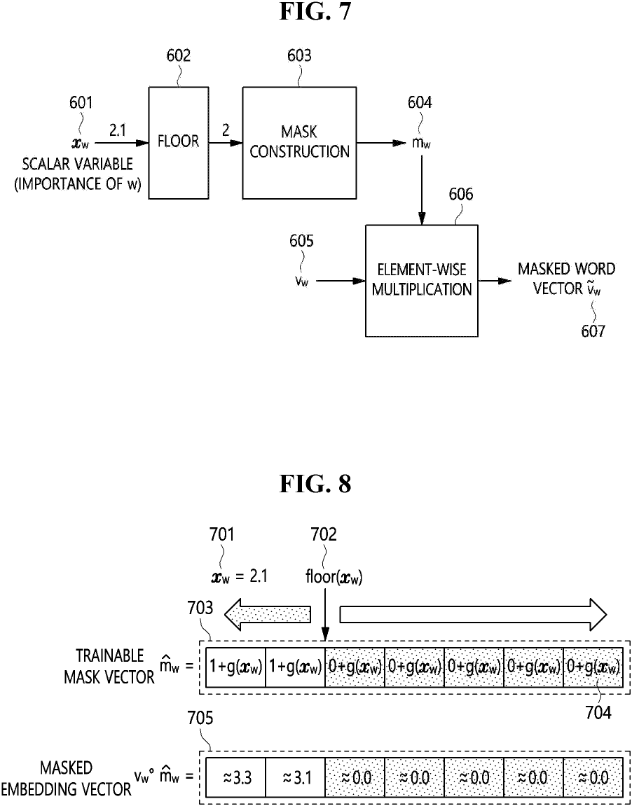

FIG. 7 is a view illustrating generation of a mask vector using a weight value indicating the importance of a discrete entity and application of the mask vector to an embedding vector.

Referring to FIG. 7, when a parameter x_{w} indicating the importance of w and having a scalar value greater than 0 is given, the process of generating a mask vector m_{w} having consecutive 0s from the end thereof can be seen.

When a weight parameter x_{w} 601 having a scalar value greater than 0 is given for a discrete entity w, an operation 602 for finding the largest integer, among integers less than the given parameter value, is performed, after which a module 603, configured to assign 1 to an index equal to or less than the found integer and assign 0 to an index greater than the found integer, calculates a mask vector m_{w} 604. Then, the element-wise multiplication 606 between the mask vector 604 generated as described above and the embedding vector v_{w} 605 of w is performed, whereby a masked vector 607 may be acquired.

FIG. 8 is a view illustrating an example of a trainable mask vector and a masked embedding vector to which the trainable mask vector is applied.

Referring to FIG. 8, when a parameter x_{w} 701 having a scalar value greater than 0 is given for a discrete entity w, an operation 702 for finding the largest integer, among integers less than the given parameter value, is performed, after which a mask vector m_{w} is calculated by assigning 1 to an index equal to or less than the found integer and assigning 0 to an index greater than the found integer. Here, a gate function 704, which is for making x_{w} trainable by transferring the gradient value received from an upper layer at the time of training to x_{w}, is added to each element of m_{w}.

The gate function therefor may be defined using any of various methods, and this function only needs to have a value very close to 0 and to have a nonzero value as the result of differentiation thereof. For example, the function shown in Equation (1) above may be used as the gate function 704.

The vector 705 generated by performing element-wise multiplication between the trainable mask vector 703, which is generated by adding the gate function 704 to each of the elements of m_{w}, and the embedding vector 301 has a value that is close to the masked embedding vector 607 calculated in FIG. 7, because the value of the gate function is very close to 0. Nevertheless, the gate function is capable of transferring a nonzero gradient value to x_{w}, whereby x_{w} optimized in the given environment may be found through training of the model.

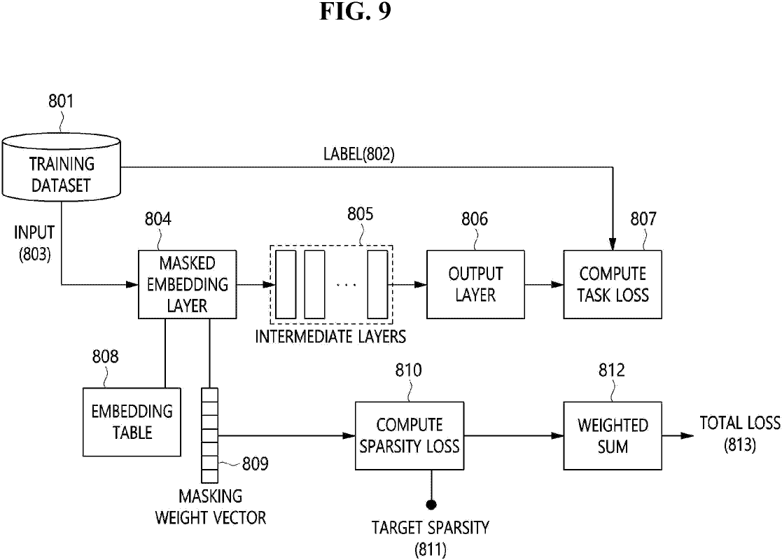

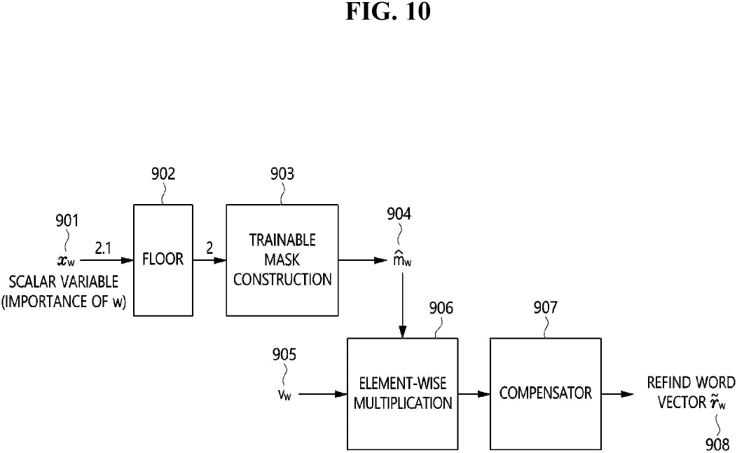

FIG. 9 is a view illustrating an example of a neural network model using an embedding layer to which trainable mask vectors are applied according to an embodiment of the present invention.

Referring to FIG. 9, input 803 received from a training dataset 801, as in the neural network model in FIG. 1, is configured with the index number of each discrete entity, and is converted into an embedding vector located in a corresponding index in an embedding table 808 when it passes through an embedding layer 804.

The converted embedding vectors are transferred to a final output layer 806 via intermediate layers 805, and the difference between the result output therefrom and a correct answer label 802 is calculated (807) and represented as a loss.

Here, the neural network model in FIG. 9 uses the embedding layer 804 to which trainable mask vectors based on the gate function of FIG. 8 are applied, rather than the embedding layer 104 in FIG. 1.

Here, the embedding layer 804 has a number of trainable parameters equal to the total number of discrete entities in order to generate a mask vector as described with reference to FIG. 8, and the trainable parameters may be represented as a weight vector 809.

Because the size of the embedding matrix 808 of the embedding layer 804 is known, a sparsity can be calculated by generating a masking vector depending on the value of each element of the weight vector 809, the difference between the sparsity and a target sparsity 811 is calculated (810) as a loss, and the process 812 of adding the result and a loss 807 corresponding to the difference between the output of the model and a correct answer thereof is performed, whereby the final loss 813 is acquired.

Here, the addition may be replaced with a weighted sum using hyperparameters.

When the model is trained through an optimization method, such as a gradient descent method, so as to minimize the calculated final loss 813, a neural network model suitable for the training dataset is computed, and a masking weight vector 809 that realizes a sparsity close to the target sparsity 811 is acquired.

Here, when the target sparsity 811 is assigned a very high value, the neural network model is automatically trained to perform selective masking depending on the importance of a discrete entity in the training process.

For example, an important word is masked less, but an unimportant word is masked more.

That is, after training is finished, words important to the given neural network model and words unimportant thereto may be automatically differentiated based on the degree of masking.

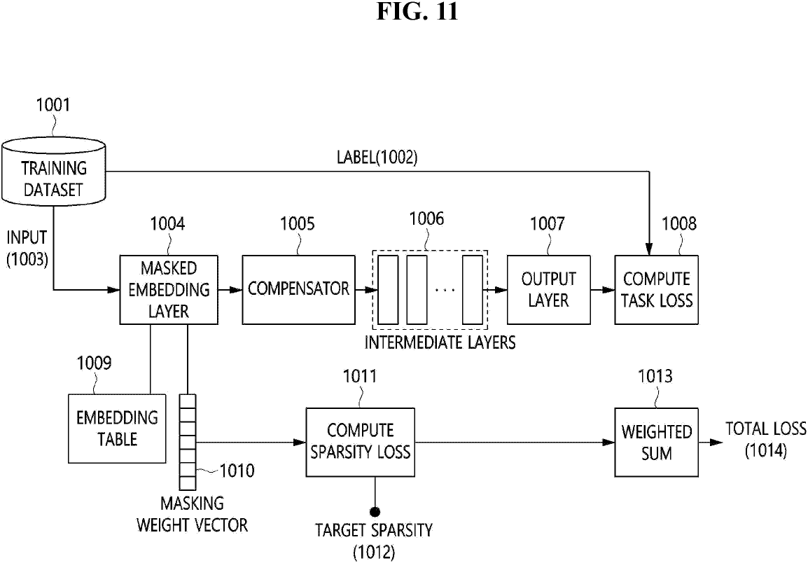

FIG. 10 is a view illustrating an example of a method for applying a compensator layer for compensating a masked embedding vector.

FIG. 10 illustrates an example configured by adding a compensator layer 907 in the example illustrated in FIG. 7. Here, the compensator layer 907 may take the masked embedding vector 607 illustrated in FIG. 7 as input, and may have the form of a fully connected layer, but is not limited thereto. The neural network model sets the value of the compensator layer 907 so as to improve the accuracy of the model through training.

By adding the compensator layer 907 as shown in FIG. 10, a rapid change in the output of the neural network layers subsequent to the embedding layer, which is caused due to application of masking to the embedding matrix, may be prevented.

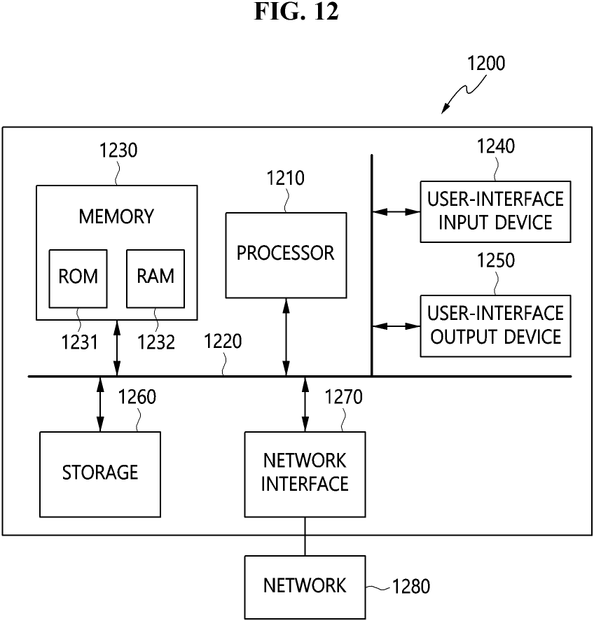

FIG. 11 is a view illustrating an example of a neural network model to which a compensator layer is applied according to an embodiment of the present invention.

Referring to FIG. 11, input 1003 received from a training dataset 1001, as in the neural network model illustrated in FIG. 9, is configured with the index number of each discrete entity, and is converted into an embedding vector located in a corresponding index in an embedding table 1009 when it passes through an embedding layer 1004.

Here, it can be seen that a compensator layer 1005 is added to the neural network model in FIG. 11, unlike in FIG. 9.

Here, the compensator layer 1005 takes the output from the embedding layer 1004 (the embedding vector of a discrete entity) as input and takes a role of compensating for the effect on intermediate layers 1006 and a final output layer 1007.

The compensated embedding vectors are transferred to the final output layer 1007 via the intermediate layers 1006, and the difference between the result output from the output layer and a correct answer label 1002 is calculated (1008) and represented as a loss.

Here, the embedding layer 1004 has a number of trainable parameters equal to the total number of discrete entities in order to generate a mask vector, and the trainable parameters may be represented as a weight vector 1010.

Because the size of the embedding matrix 1009 of the embedding layer 1004 is known, a sparsity can be calculated by generating a masking vector depending on the value of each element of the weight vector 1010. Then, the difference between the sparsity and a target sparsity 1012 is calculated (1011) as a loss, and the process (1013) of adding the result and a loss 1008 corresponding to the difference between the output of the model and a correct answer thereof is performed, whereby a final loss 1014 is acquired.

Here, the addition may be replaced with a weighted sum using hyperparameters.

When the model is trained using an optimization method, such as a gradient descent method, so as to minimize the calculated final loss 1014, a neural network model suitable for the training dataset is computed, and a masking weight vector 1010 that realizes a sparsity close to the target sparsity 1012 is acquired.

FIG. 12 is a view illustrating a computer system configuration according to an embodiment.

The apparatus for measuring the weight of a discrete entity according to an embodiment may be implemented in a computer system 1200 including a computer-readable recording medium.

The computer system 1200 may include one or more processors 1210, memory 1230, a user-interface input device 1240, a user-interface output device 1250, and storage 1260, which communicate with each other via a bus 1220. Also, the computer system 1200 may further include a network interface 1270 connected to a network 1280. The processor 1210 may be a central processing unit or a semiconductor device for executing a program or processing instructions stored in the memory 1230 or the storage 1260. The memory 1230 and the storage 1260 may be storage media including at least one of a volatile medium, a nonvolatile medium, a detachable medium, a non-detachable medium, a communication medium, and an information delivery medium. For example, the memory 1230 may include ROM 1231 or RAM 1232.

The apparatus for measuring the weight of a discrete entity according to an embodiment of the present invention includes memory in which at least one program is recorded and a processor for executing the program. The program includes instructions for performing steps of receiving data configured with the indices of discrete entities, converting the data into embedding vectors corresponding to respective indices through an embedding layer, generating a masked vector through element-wise multiplication between a mask vector and the embedding vector, calculating a loss using the output based on the masked vector, and training the model based on the loss.

Here, generating the masked vector may include performing a floor operation on a weight value for the discrete entity, assigning 1 to an index corresponding to an integer equal to or less than the value resulting from the floor operation, and assigning 0 to an index corresponding to an integer greater than the value resulting from the floor operation.

Here, the mask vector may be configured such that, among the elements of the embedding vector, the values to be used are represented as 1 and the values not to be used are represented as 0.

Here, generating the masked vector may further include adding a value corresponding to a gate function for learning the weight value to each of the elements of the masked vector.

Here, the gate function may be a function having a value close to 0 such that learning of the weight value is possible, and a function that is differentiable in a preset section.

Here, the gate function may correspond to the function of Equation (1) above, and L in Equation (1) may be a sufficiently large positive value.

Here, calculating the loss may comprise calculating a final loss based on a first loss corresponding to the difference between the output of the neural network model and a correct answer thereof and on a second loss corresponding to the difference between a target sparsity and the sparsity of a masking vector generated based on a weight vector configured with weight values for the respective discrete entities.

Here, generating the masked vector may further include compensating for a rapid change in output, which is caused due to application of masking to the embedding vector.

Existing importance measurement methods are limited in that the importance of a discrete entity is determined using a heuristic method based on a frequency, but the technology proposed in the present invention determines the importance of respective discrete entities contributing to the inference of a neural network model through optimization based on training data.

Accordingly, the method according to an embodiment of the present invention determines importance through optimization based on actual given training data, whereby an effective importance distribution may always be found, regardless of the task.

Also, because the present invention is task-agnostic, it may be used to determine the importance of an entity in a field dealing with arbitrary discrete entities.

Also, the method proposed in the present invention is always applicable to an arbitrary method for compressing an embedding matrix.

If a given embedding matrix is divided into partial matrices based on the importance of entities and a certain compression method is applied to each of the partial matrices, a method of calculating the average importance of each of the partial matrices and using the same to determine the degree of compression is feasible. That is, because the technology of the present invention optimally calculates the importance of an entity in a model, a performance improvement may be generally expected regardless of the compression method.

According to the present invention, a method for measuring the optimum importance of each entity in a neural network model for processing discrete entities may be provided.

Also, the present invention may provide the importance of each discrete entity such that a method for lightening an embedding layer is effectively applied.

Specific implementations described in the present invention are embodiments and are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. A method for measuring a weight of a discrete entity, performed in a neural network model configured with multiple layers, comprising:
receiving data configured with indices of discrete entities;
converting the data into embedding vectors corresponding to respective indices through an embedding layer;
generating a masked vector through element-wise multiplication between a mask vector and the embedding vector;
calculating a loss using output based on the masked vector; and
training the model based on the loss.

2. The method of claim 1, wherein:
generating the masked vector includes
performing a floor operation on a weight value for the discrete entity;
assigning 1 to an index corresponding to an integer equal to or less than a value resulting from the floor operation; and
assigning 0 to an index corresponding to an integer greater than the value resulting from the floor operation.

3. The method of claim 2, wherein:
the mask vector represents values to be used as 1 and represents values not to be used as 0, among elements of the embedding vector.

4. The method of claim 2, wherein:
generating the masked vector further includes
adding a value corresponding to a gate function for learning the weight value to each of elements of the masked vector.

5. The method of claim 4, wherein:
the gate function has a value close to 0 such that learning of the weight value is possible, and is a function that is differentiable in a preset section.

6. The method of claim 5, wherein:
the gate function is a function of Equation (1) below, and L is a positive integer equal to or greater than 1000.
$$\text{B} \left(\text{x}\right) = \frac{L x - \left⌊L x\right⌋}{L}$$
.

7. The method of claim 5, wherein:
calculating the loss comprises calculating a final loss based on a first loss corresponding to a difference between output and a correct answer of the neural network model and on a second loss corresponding to a difference between a target sparsity and a sparsity of a masking vector generated based on a weight vector configured with respective weight values for the discrete entities.

8. The method of claim 7, wherein:
generating the masked vector further includes compensating for a rapid change in output, which is caused due to application of masking to the embedding vector.

9. An apparatus for measuring a weight of a discrete entity, comprising:
memory in which at least one program is recorded; and
a processor for executing the program,
wherein the program includes instructions for performing
receiving data configured with indices of discrete entities;
converting the data into embedding vectors corresponding to respective indices through an embedding layer;
generating a masked vector through element-wise multiplication of a mask vector and the embedding vector;
calculating a loss using output based on the masked vector; and
training a model based on the loss.

10. The apparatus of claim 9, wherein:
generating the masked vector includes
performing a floor operation on a weight value for the discrete entity;
assigning 1 to an index corresponding to an integer equal to or less than a value resulting from the floor operation; and
assigning 0 to an index corresponding to an integer greater than the value resulting from the floor operation.

11. The apparatus of claim 10, wherein:
the mask vector represents values to be used as 1 and represents values not to be used as 0, among elements of the embedding vector.

12. The apparatus of claim 10, wherein:
generating the masked vector further includes
adding a value corresponding to a gate function for learning the weight value to each of elements of the masked vector.

13. The apparatus of claim 12, wherein:
the gate function has a value close to 0 such that learning of the weight value is possible, and is a function that is differentiable in a preset section.

14. The apparatus of claim 13, wherein:
the gate function is a function of Equation (1) below, and L is a positive integer equal to or greater than 1000.
$$\text{B} \left(\text{x}\right) = \frac{L x - \left⌊L x\right⌋}{L}$$
.

15. The apparatus of claim 13, wherein:
calculating the loss comprises calculating a final loss based on a first loss corresponding to a difference between output and a correct answer of a neural network model and on a second loss corresponding to a difference between a target sparsity and a sparsity of a masking vector generated based on a weight vector configured with respective weight values for the discrete entities.

16. The apparatus of claim 15, wherein:
generating the masked vector further includes compensating for a rapid change in output, which is caused due to application of masking to the embedding vector.
